(19) United States
(12) Patent Application Publication
(10) Pub. No.: US 2015/0348700 A1
(43) Pub. Date: Dec. 3, 2015

(54) ON-CHIP INDUCTOR AND METHOD FOR MANUFACTURING THE SAME

(71) Applicant: Samsung Electro-Mechanics Co., Ltd., Suwon (KR)

(72) Inventors: Kyung Hee HONG, Suwon (KR); Jeong Hoon KIM, Suwon (KR); Suk Chan KANG, Suwon (KR); Joong Jin NAM, Suwon (KR); Kyu Jin Choi, Suwon (KR); Jae Hyouck Choi, Suwon (KR)

(73) Assignee: Samsung Electro-Mechanics Co., Ltd., Suwon (KR)

(21) Appl. No.: 14/481,021

(22) Filed: Sep. 9, 2014

(30) Foreign Application Priority Data
Jun. 3, 2014 (KR) 10-2014-0067812

(51) Int. Cl. H01F 27/36; H01F 41/04; H01F 27/28

(52) U.S. Cl. CPC H01F 27/362; H01F 27/2804; H01F 41/041

(57) ABSTRACT

There are provided an on-chip inductor, and a method for manufacturing the same. The on-chip inductor may include: a substrate; an oxide layer formed on the substrate; a spiral-shaped wiring layer formed on the oxide layer; and a shielding layer having a lattice shape interposed between the substrate and the wiring layer.

### CROSS-REFERENCE TO RELATED APPLICATION

This application claims the benefit of Korean Patent Application No. 10-2014-0067812 filed on Jun. 3, 2014, with the Korean Intellectual Property Office, the disclosure of which is incorporated herein by reference.

### BACKGROUND

The present disclosure relates to an on-chip inductor and a method for manufacturing the same.

Recently, on-chip inductors have been widely used in implementing Radio Frequency Integrated Circuits (RF IC).

A silicon (Si)-based process has mainly been used in manufacturing on-chip inductors, due to the fact that this process may be implemented at relatively low cost and has various advantages in terms of mass production, as compared to other processes.

In the case of implementing an inductor as an on-chip inductor, circuits are integrated as a single circuit, such that advantages such as miniaturization, low cost, and design stabilization, and the like exist, but such on-chip inductors may be more rapidly deteriorated, as compared to off-chip inductors.

Particularly, since Q factors of inductors may be deteriorated due to energy loss in a semiconductor substrate in a high RF IC implemented in the widely applied silicon (Si)-based process, and a planar inductor may occupy a significant area, noise coupling through the substrate in a GHz band, or the like, may act as a factor deteriorating performance of an entire circuit.

Various methods have been attempted in order to solve the above-mentioned problems.

For example, a method of implementing a silicon (Si) substrate as a high resistance substrate, a method of implementing an etching pit below an inductor, and the like, have been attempted.

However, in the method of implementing the silicon (Si) substrate as a high resistance substrate, costs may be increased, and in the method of implementing the etching pit, additional costs may be incurred. In addition, these methods have disadvantages in that cost competitiveness may be decreased due to additional costs being incurred, and yield and reliability may also be deteriorated.

Therefore, a method capable of solving the above-mentioned problems within a standard process without requiring an additional process remains in demand.

Meanwhile, as the method capable of solving the above-mentioned problems within a standard process without requiring an additional process, an attempt to improve a quality factor (Q factor) by inserting a shielding layer in a direction orthogonal with respect to a current direction of an inductor between the inductor and a substrate and shortening an electric field at a boundary surface of the substrate to thereby decrease an influence of resistance of the substrate has been conducted.

However, in the case of inserting the shielding layer in a direction orthogonal with respect to the current direction of the inductor as described above, parasitic capacitance corresponding to an area of the inductor may be generated, and resonance may be generated due to inductance of the inductor and parasitic capacitance, such that a self resonant frequency (SRF) may move toward a low frequency.

Since the inductor may not store magnetic energy anymore at a frequency higher than the self resonant frequency (SRF), there was a problem in that the inductor may not be used as an inductor device in a circuit at a frequency higher than the self resonant frequency (SRF).

### RELATED ART DOCUMENT

### (Patent Document 1) Japanese Patent Laid-Open Publication No. 2000-077610

### SUMMARY

An exemplary embodiment in the present disclosure may provide an on-chip inductor and a method for manufacturing the same.

According to an exemplary embodiment in the present disclosure, an on-chip inductor may include: a substrate; an oxide layer formed on the substrate; a spiral-shaped wiring layer formed on the oxide layer; and a shielding layer having a lattice shape interposed between the substrate and the wiring layer.

The lattice shape may be isotropic.

The lattice shape may be a polygonal shape having a symmetrical structure.

The shielding layer may be formed of one or more of metals and polysilicon.

The shielding layer may be formed in an entire inductor cell region.

The shielding layer may be formed in an inductor strip region.

According to an exemplary embodiment in the present disclosure, a method for manufacturing an on-chip inductor may include: preparing a substrate; forming an oxide layer on the substrate; forming a spiral-shaped wiring layer on the oxide layer; and inserting a shielding layer having a lattice shape between the substrate and the wiring layer.

The lattice shape may be isotropic.

The lattice shape may be a polygonal shape having a symmetrical structure.

The shielding layer may be formed of one or more of metals and polysilicon.

The shielding layer may be formed in an entire inductor cell region.

The shielding layer may be formed in an inductor strip region.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating an on-chip inductor according to an exemplary embodiment in the present disclosure;

FIG. 2 is a cross-sectional view taken along line A-A′ of FIG. 1;

FIG. 3 is a plan view of FIG. 1;

FIG. 4 is an equivalent circuit view of the on-chip inductor illustrated in FIG. 1;

FIG. 5 is a plan view of an on-chip inductor according to another exemplary embodiment in the present disclosure;

FIG. 6 is a graph illustrating changes in a self resonant frequency (SRF) according to Inventive Examples and Comparative Examples in the present disclosure;

FIG. 7 is a graph illustrating changes in a quality factor (Q factor) according to Inventive Examples and Comparative Examples in the present disclosure; and

FIG. 8 is a manufacturing process view of an on-chip inductor according to an exemplary embodiment in the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

On-Chip Inductor

Hereinafter, exemplary embodiments of the present disclosure will be described in detail with reference to the accompanying drawings.

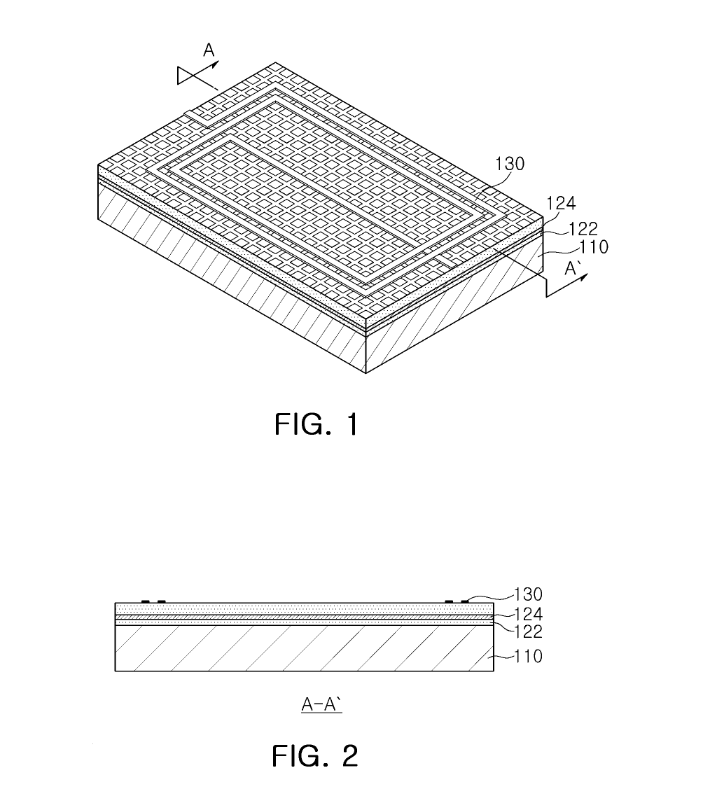

FIG. 1 is a perspective view schematically illustrating an on-chip inductor according to an exemplary embodiment in the present disclosure.

FIG. 2 is a cross-sectional view taken along line A-A′ of FIG. 1.

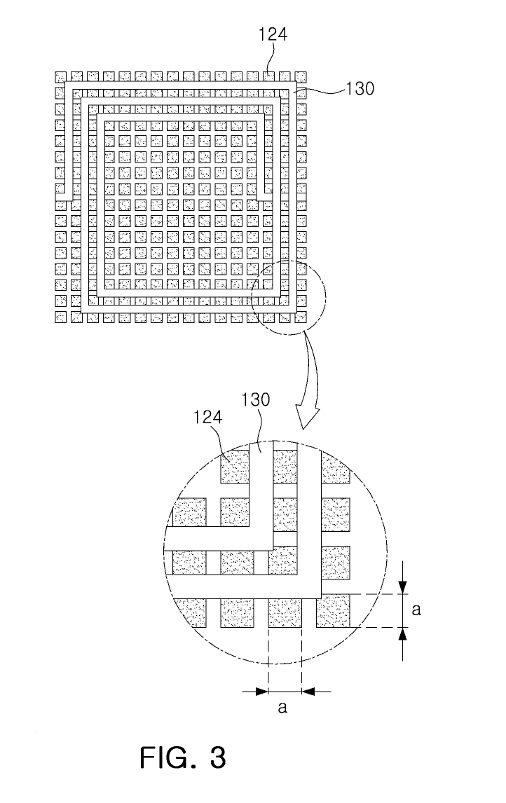

FIG. 3 is a plan view of FIG. 1.

Referring to FIGS. 1 through 3, the on-chip inductor according to an exemplary embodiment of the present disclosure may include a substrate 110; an oxide layer 122 formed on the substrate 110; and a spiral-shaped wiring layer 130 formed on the oxide layer 122; and a shielding layer 124 having a lattice shape interposed between the substrate 110 and the wiring layer 130.

In the present exemplary embodiment, the on-chip inductor may include the substrate 110, wherein the substrate 110 is not particularly limited, but may be, for example, formed of a silicon (Si)-based material.

The on-chip inductor may include the oxide layer 122 formed on the substrate 110.

The oxide layer 122 is required for adhesion with the wiring layer forming an inductor and may be, for example, a silicon dioxide (SiO₂) layer, but is not limited thereto.

The on-chip inductor may include the spiral-shaped wiring layer 130 formed on the oxide layer 122.

The spiral-shaped wiring layer 130, which forms the inductor, may be formed of an aluminum (Al)-based material or copper a (Cu)-based material, but is not limited thereto.

In the present exemplary embodiment, the on-chip inductor may include the shielding layer 124 having a lattice shape interposed between the substrate 110 and the wiring layer 130.

In general, since a quality factor (Q factor) of an inductor may be decreased by energy loss in a semiconductor substrate in a high radio frequency integrated circuit (RF IC) implemented in a silicon (Si)-based process, and a planar inductor occupies a significant area, the noise coupling through the substrate in a GHz band, or the like, acts as a factor deteriorating performance of an entire circuit.

According to the related art, various methods have been attempted in order to solve the above-mentioned problems.

For example, a method of implementing a silicon (Si) substrate as a high resistance substrate, in addition to a method of implementing an etching pit below an inductor, and others, has been attempted.

However, in the method of implementing the silicon (Si) as the high resistance substrate, costs may be increased, and in the method of implementing the etching pit, additional costs may be incurred. In addition, these methods have disadvantages in that cost competitiveness may be decreased, due to additional costs being incurred, and yield and reliability thereof may be deteriorated.

Therefore, a method capable of solving the above-mentioned problems utilizing a standard process without requiring an additional process has been demanded.

Meanwhile, as the method capable of solving the above-mentioned problems within a standard process without requiring an additional process, an attempt to improve Q factor by inserting a shielding layer disposed to be orthogonal with respect to a current direction of an inductor between the inductor and a substrate and shorting an electric field at a boundary surface of the substrate to thereby decrease an influence of a resistance of the substrate has been conducted.

However, in the case of inserting the shielding layer disposed to be orthogonal with respect to the current direction of the inductor as described above, parasitic capacitance corresponding to an area of the inductor may be generated, and resonance may be generated due to inductance of the inductor and parasitic capacitance, such that a self resonant frequency (SRF) may move toward a low frequency.

Since the inductor may not store magnetic energy at frequencies higher than the self resonant frequency (SRF), there was a problem in that the inductor may not be used as an inductor device in a circuit at a frequency higher than the self resonant frequency (SRF).

However, the on-chip inductor according to an exemplary embodiment of the present disclosure may include the shielding layer 124 having a lattice shape interposed between the substrate 110 and the wiring layer 130, such that Q factor may be improved without a decrease of a self resonant frequency (SRF).

That is, since the on-chip inductor according to an exemplary embodiment of the present disclosure includes a symmetrical shielding layer 124 having a lattice shape interposed between the substrate 110 and the inductor formed of the wiring layer 130, an electric field at a boundary surface of the substrate may be shielded, and thus, an energy loss in the substrate may be significantly decreased, thereby improving Q factor.

In addition, an influence of an image current, a side effect, may be significantly deceased, whereby a decrease of the self resonant frequency (SRF) generated due to a shielding structure may be significantly decreased without decreasing inductance of the inductor.

Referring to FIG. 3, the shielding layer 124 may have a lattice shape, and the lattice shape may be isotropic.

That is, in the case in which the shielding layer 124 has a tetragonal lattice shape as illustrated in FIG. 3, since a length and a width of each tetragonal lattice are a and are the same as each other, the influence of the image current that may be generated due to the interposition of the shielding layer, a conductive material, may be significantly decreased.

More specifically, in the case of inserting a shielding layer formed of a conductive material in order to solve problems such as deterioration of Q factor of the inductor, noise coupling through the substrate in a GHz band due to the planar inductor occupying a significant area, and the like, parasitic capacitance corresponding to the area of the inductor may be generated, and thus, the self resonant frequency (SRF) may be decreased.

In the case of inserting a conductive shielding layer having a general shape, problems such as the noise coupling, or the like may be solved, but problems such as generation of parasitic capacitance due to the image current and a decrease of the self resonant frequency (SRF) due to parasitic capacitance may be caused.

However, according to an exemplary embodiment of the present disclosure, since the shielding layer 124 may have the lattice shape, and the lattice shape is isotropic, the generation of the image current in the shielding layer may be significantly decreased, thereby preventing the self resonant frequency (SRF) from being decreased.

That is, even though image currents may be generated, since the currents may flow in the isotropic lattice shape to thereby be offset from each other, the generation of parasitic capacitance may be prevented, such that the decrease of the self resonant frequency (SRF) may be significantly decreased.

Meanwhile, the lattice shape may be a polygonal shape having a symmetrical structure, but is not limited thereto.

Although the shielding layer having a tetragonal lattice shape of which the length and the width are a is illustrated in FIG. 3, the shielding layer is not limited thereto, and the shielding layer may have another lattice shape as long as it has a symmetrical structure. For example, the shielding layer may have a hexagonal or octagonal lattice shape.

The shielding layer 124 may be formed of one or more of metals and polysilicon.

That is, according to an exemplary embodiment of the present disclosure, the shielding layer 124 may be formed of a conductive material. Although not limited thereto, the shielding layer 124 may be formed of, for example, any one or more of the metals and polysilicon.

Referring to FIG. 3, in the on-chip inductor according to an exemplary embodiment of the present disclosure, the shielding layer 124 may be formed in an entire inductor cell region.

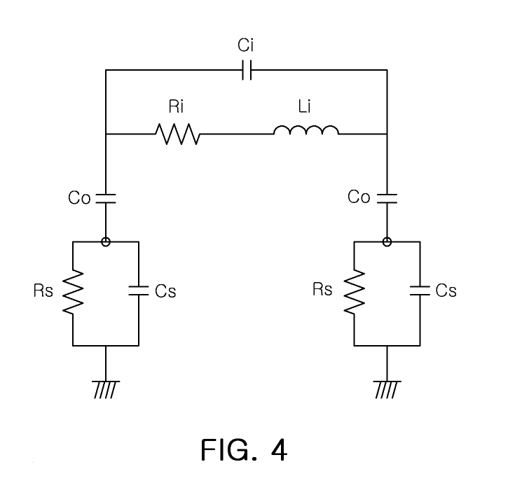

FIG. 4 is an equivalent circuit diagram of the on-chip inductor illustrated in FIG. 1.

Referring to FIG. 4, in the on-chip inductor, inductance Li, resistance Ri by metal resistance implementing the inductor, and capacitance Ci, self series capacitance generated due to the inductor occupying an area, may be generated in an inductor region.

Meanwhile, capacitance Co may be generated by the oxide layer formed between the substrate and the inductor region.

Then, resistance Rs and capacitance Cs may be generated in a lower substrate, illustrated in FIG. 4.

In the on-chip inductor, Q factor may be deteriorated by an energy loss in a high frequency region.

The energy loss may be generated by resistance Ri by the metal resistance implementing the inductor and resistance Rs by the lower substrate.

In a standard process, in order to block the energy loss without an additional process, the shielding layer 124 having a lattice shape for shielding the electric field may be interposed between the substrate 110 and the wiring layer 130.

Therefore, while the inductance may be maintained, the decrease of the Q factor by the energy loss may be prevented.

In addition, since the shielding layer 124 has an isotropic or symmetrical polygonal lattice shape, image currents that may be generated in the shielding layer 124 may be offset from each other, such that the decrease of the self resonant frequency (SRF) may be significantly decreased by preventing parasitic capacitance from being generated.

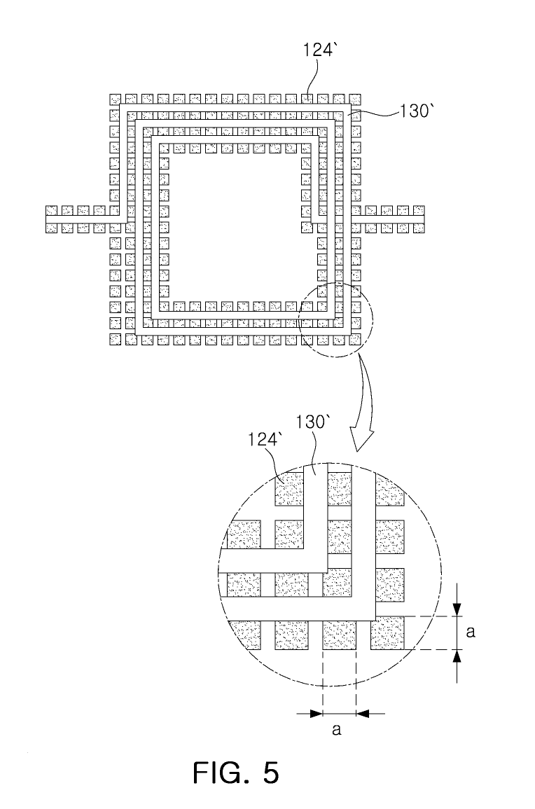

FIG. 5 is a plan view of an on-chip inductor according to an exemplary embodiment in the present disclosure.

Referring to FIG. 5, in the on-chip inductor according to another exemplary embodiment of the present disclosure, a shielding layer 124′ may be formed in an inductor strip region.

The shielding layer 124′ is formed in the inductor strip region, which means that inductor is formed to conform to a shape of a wiring layer so as to shield only a spiral-shaped wiring layer 130′ forming the inductor.

That is, according to another exemplary embodiment of the present disclosure, the shielding layer 124′ is formed so as to shield only the spiral-shaped wiring layer 130′ forming the inductor, such that inductance of the inductor may not be decreased, and at the same time, a reduction in a self resonant frequency (SRF) generated due to a shielding structure may be significantly decreased.

That is, the decrease of a self resonant frequency (SRF) may be effectively prevented by decreasing a region of the shielding layer.

Hereinafter, changes in the self resonant frequency (SRF) and Q factor according to Inventive Examples and Comparative Examples of the present disclosure will be compared and described, but the present disclosure is not limited thereto.

In Inventive Example of the present disclosure, an on-chip inductor having a structure in which a shielding layer shields the entire inductor cell (Inventive Example 1) and an on-chip inductor having a structure in which a shielding layer partially shields an inductor strip region (Inventive Example 2) were manufactured.

On the other hand, in Comparative Example 1, a standard inductor not including the shielding layer and having inductance of 5.4 nH in a 2 GHz band was manufactured, and in Comparative Example 2, an on-chip inductor in which a shielding layer disposed to be orthogonal with respect to a current direction of the inductor is inserted was manufactured.

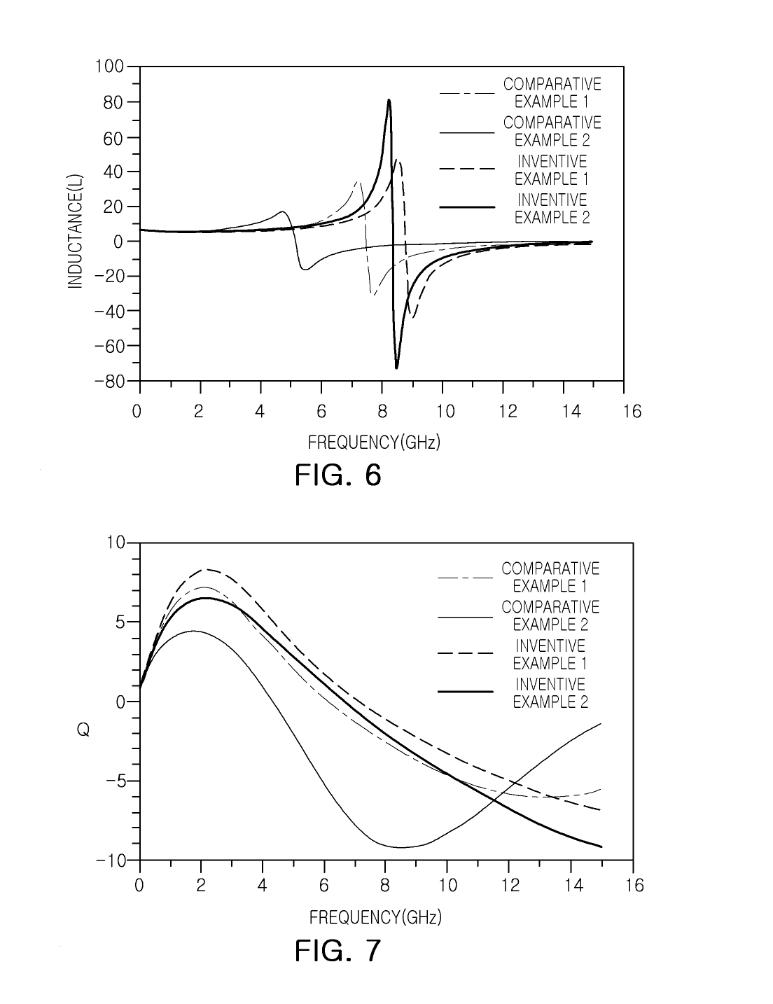

FIG. 6 is a graph illustrating changes in a self resonant frequency (SRF) according to Inventive Examples and Comparative Examples in the present disclosure.

Referring to FIG. 6, it may be appreciated that in Inventive Examples 1 and 2 into which the shielding layer having an isotropic or symmetrical lattice shape was inserted, the self resonance frequency (SRF) was almost equal to that in Comparative Example 1 in which the shielding layer was not inserted into or moved toward a higher frequency region.

On the contrary, it may be appreciated that in Comparative Example 2 in which the shielding layer disposed to be orthogonal with respect to the current direction of the inductor was inserted, the self resonance frequency (SRF) moved toward a low frequency region, such that there was a limitation in a use range of the inductor.

FIG. 7 is a graph illustrating changes in Q factor according to Inventive Examples and Comparative Examples in the present disclosure.

Referring to FIG. 7, it may be appreciated that in Inventive Examples 1 and 2 in which the shielding layer having an isotropic or symmetrical lattice shape was inserted, the Q factor was almost equal to that in Comparative Example 1 in which the shielding layer was not inserted.

On the contrary, it may be appreciated that in Comparative Example 2 in which the shielding layer disposed to be orthogonal with respect to the current direction of the inductor was inserted, the Q factor was deteriorated as compared to Inventive Examples 1 and 2, and Comparative Example 1 in which the shielding layer was not inserted.

Method for Manufacturing on-Chip Inductor

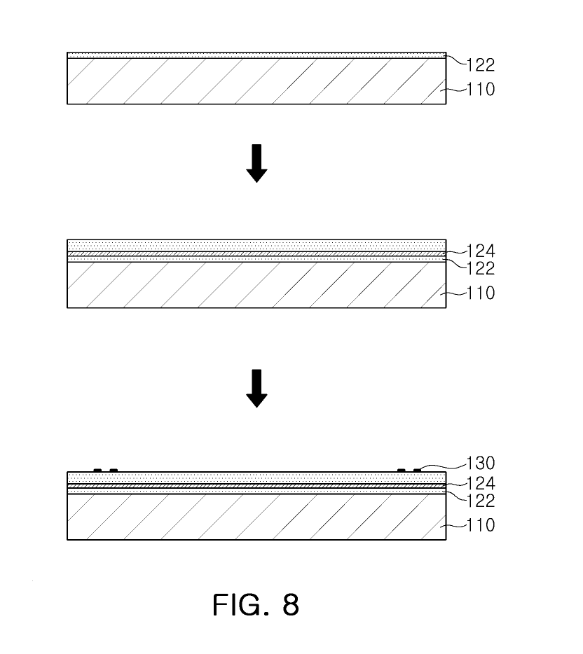

FIG. 8 is a manufacturing process view of an on-chip inductor according to another exemplary embodiment in the present disclosure.

Hereinafter, a method for manufacturing an on-chip inductor according to another exemplary embodiment of the present disclosure will be described, but is not limited thereto.

In the manufacturing process of an on-chip inductor according to another exemplary embodiment of the present disclosure, first, a substrate formed of silicon (Si) may be prepared.

Then, an oxide layer containing silicon dioxide (SiO₂) may be formed on the substrate for adhesion with a wiring layer forming the inductor.

Next, a spiral-shaped wiring layer formed of an aluminum (Al) or copper (Cu)-based material may be formed on the oxide layer, and the wiring layer may configure the inductor.

According to another exemplary embodiment of the present disclosure, a shielding layer having a lattice shape may be interposed between the substrate and the wiring layer.

A process of inserting the shielding layer may be implemented by a method of forming the shielding layer on the substrate or by a method of forming the oxide layer and the wiring layer and then inserting the shielding layer between the substrate and the wiring layer, but is not particularly limited.

The lattice shape may be isotropic or a polygonal shape having a symmetrical structure.

The shielding layer may be formed of one or more of metals and polysilicon.

The shielding layer may be formed in the entire inductor cell region or an inductor strip region.

As set forth above, according to exemplary embodiments of the present disclosure, the on-chip inductor capable of improving Q factor without decreasing the self resonant frequency (SRF) may be provided by inserting the symmetrical shielding layer having a lattice shape between the inductor and the substrate.

That is, since the on-chip inductor according to exemplary embodiments of the present disclosure includes the symmetrical shielding layer having a lattice shape interposed between the substrate and the wiring layer, the electric field at the boundary surface of the substrate may be shielded, and thus, the energy loss in the substrate may be significantly decreased, thereby improving Q factor.

In addition, the influence of the image current, the side effect, may be significantly deceased, whereby the decrease in the self resonant frequency (SRF) generated due to the shielding structure may be significantly decreased without decreasing inductance of the inductor.

While exemplary embodiments have been shown and described above, it will be apparent to those skilled in the art that modifications and variations could be made without departing from the spirit and scope of the present disclosure as defined by the appended claims.

What is claimed is:

1. An on-chip inductor comprising:
a substrate;
an oxide layer disposed on the substrate;
a spiral-shaped wiring layer disposed on the oxide layer; and
a shielding layer having a lattice shape interposed between the substrate and the wiring layer.

2. The on-chip inductor of claim 1, wherein the lattice shape is isotropic.

3. The on-chip inductor of claim 1, wherein the lattice shape is a polygonal shape having symmetrical structure.

4. The on-chip inductor of claim 1, wherein the shielding layer is formed of one or more of metals and polysilicon.

5. The on-chip inductor of claim 1, wherein the shielding layer is formed in an entire inductor cell region.

6. The on-chip inductor of claim 1, wherein the shielding layer is formed in an inductor strip region.

7. A method for manufacturing an on-chip inductor, the method comprising:
preparing a substrate;
forming an oxide layer on the substrate;
forming a spiral-shaped wiring layer on the oxide layer; and
inserting a shielding layer having a lattice shape between the substrate and the wiring layer.

8. The method of claim 7, wherein the lattice shape is isotropic.

9. The method of claim 7, wherein the lattice shape is a polygonal shape having symmetrical structure.

10. The method of claim 7, wherein the shielding layer is formed of one or more of metals and polysilicon.

11. The method of claim 7, wherein the shielding layer is formed in an entire inductor cell region.

12. The method of claim 7, wherein the shielding layer is formed in an inductor strip region.
